(19) United States
(12) Patent Application Publication
(10) Pub. No.: US 2013/0171485 A1
(43) Pub. Date: Jul. 4, 2013

(54) BATTERY MODULE AND PRODUCTION METHOD THEREFOR

(71) Applicant: HITACHI, LTD., Tokyo (JP)

(72) Inventors: Yuji KODERA, Kyoto (JP); Tatsuya KAMADA, Kyoto (JP); Hitoshi WATANABE, Kyoto (JP)

(73) Assignee: HITACHI, LTD., Tokyo (JP)

(21) Appl. No.: 13/710,096

(22) Filed: Dec. 10, 2012

(30) Foreign Application Priority Data
Jan. 4, 2012 (JP) 2012-000097

(51) Int. Cl. H01M 10/04

(52) U.S. Cl. CPC H01M 10/045
USPC 429/90; 429/152; 429/153; 29/623.1

(57) ABSTRACT

A battery module including a plurality of thin plate batteries that have a substantially rectangular shape as viewed from above and that are placed one on top of the other is disclosed. The thin plate batteries each have a positive electrode tab and a negative electrode tab extending from a front side. The positive electrode tab and the negative electrode tab of adjacent thin plate batteries face each other. The positive electrode tab and the negative electrode tab that face each other are electrically connected such that the thin plate batteries are connected in series. An electrically conducting path that electrically connects the positive electrode tab and the negative electrode tab is folded along a folding line that is parallel to a lateral side adjacent to the front side.

### BACKGROUND OF THE INVENTION

1. Field of the Invention

The present invention relates to a battery module composed of a plurality of thin plate batteries placed one on top of the other, and a production method therefor.

2. Description of the Related Art

Non-queous electrolyte batteries represented by lithium-ion secondary batteries have high energy densities, and therefore have been used for power sources of transportation devices such as automobiles and motorcycles, personal digital assistants, uninterruptible power supplies (UPSs), and the like. In such applications, in order to further enhance energy density, large quantities of laminated lithium-ion secondary batteries in a thin plate form in which power generating elements are externally furnished with a flexible laminate sheet are commonly used. Moreover, battery modules in which a plurality of thin plate secondary batteries are placed one on top of the other and are connected in series to obtain the desired battery capacity are in practical use (see, for example, Japanese Patent No. 4-499977).

Conventional battery modules are produced by repeating, for the number of required thin plate batteries, an operation in which a thin plate battery is placed on top of another thin plate battery that is on the lower side and then electrode tabs that face each other and that have different polarities (that is, a positive electrode tab and a negative electrode tab) of the upper and lower thin plate batteries are electrically connected.

Such a battery module production operation is problematic in that it is a spatially complex operation, thus making it difficult to automate the operation, requiring manual labor of a worker, and resulting in poor work efficiency. Also, it is problematic in that when connecting the electrode tabs with different polarities of the upper and lower thin plate batteries, there is a risk of a short circuit accident caused by accidental contact of a connecting tool with an electrode tab that is located above or below the electrode tab to be connected.

### SUMMARY OF THE INVENTION

An object of the present invention is to provide a battery module that can be easily produced and with which a short circuit accident is unlikely to occur in an electrode tab connecting operation, and a production method therefor.

A battery module of the present invention is a battery module in which a plurality of thin plate batteries having a rectangular shape as viewed from above are placed on top of the other. The plurality of thin plate batteries each have a positive electrode tab and a negative electrode tab extending from a front side. The positive electrode tab and the negative electrode tab of adjacent thin plate batteries face each other. The positive electrode tab and the negative electrode tab that face each other are electrically connected such that the plurality of thin plate batteries are connected in series. An electrically conducting path that electrically connects the positive electrode tab and the negative electrode tab is folded along a folding line that is parallel to a lateral side adjacent to the front side.

A method for producing a battery module of the present invention includes the successive steps of (a) providing a plurality of thin plate batteries each having a substantially rectangular shape as viewed from above and including a positive electrode tab and a negative electrode tab extending from a front side, (b) arranging the plurality of thin plate batteries on the same plane such that the front sides of the plurality of thin plate batteries form a straight line and such that the positive electrode tabs and the negative electrode tabs of the plurality of thin plate batteries are alternately disposed in a direction parallel to the front sides, (c) electrically connecting the positive electrode tab and the negative electrode tab between adjacent thin plate batteries such that the plurality of thin plate batteries are connected in series, and (d) placing the adjacent thin plate batteries one on top of the other by folding an electrically conducting path that electrically connects the positive electrode tab and the negative electrode tab along a folding line that is parallel to lateral sides adjacent to the front sides.

### BRIEF DESCRIPTION OF THE DRAWINGS

FIG. 1A is a perspective view of a three-side-sealed thin plate battery as viewed from above, and FIG. 1B is a perspective view thereof as viewed from below.

FIG. 2A is a perspective view of a four-side-sealed thin plate battery as viewed from above, and FIG. 2B is a perspective view thereof as viewed from below.

FIG. 3A is a perspective view showing one step of a production method of a battery module according to Embodiment 1 of the present invention.

FIG. 3B is a perspective view showing one step of a production method of a battery module according to Embodiment 1 of the present invention.

FIG. 3C is a perspective view showing one step of a production method of a battery module according to Embodiment 1 of the present invention.

FIG. 3D is a perspective view showing one step of a production method of a battery module according to Embodiment 1 of the present invention.

FIG. 3E is a perspective view showing one step of a production method of a battery module according to Embodiment 1 of the present invention.

FIG. 3F is a perspective view showing a schematic configuration of a battery module according to Embodiment 1 of the present invention.

FIG. 4A is a perspective view showing one step of a production method of a battery module according to Embodiment 2 of the present invention.

FIG. 4B is a perspective view showing one step of a production method of a battery module according to Embodiment 2 of the present invention.

FIG. 4C is a perspective view showing one step of a production method of a battery module according to Embodiment 2 of the present invention.

FIG. 4D is a perspective view showing one step of a production method of a battery module according to Embodiment 2 of the present invention.

FIG. 4E is a perspective view showing a schematic configuration of a battery module according to Embodiment 2 of the present invention.

FIG. 5 is a perspective view of another thin plate battery as viewed from above that can be preferably used in a battery module of Embodiment 2 of the present invention.

FIG. 6A is a perspective view of a thin plate battery as viewed from above that is used in a battery module of Embodiment 3 of the present invention.

FIG. 6B is a perspective view of another thin plate battery as viewed from above that is used in a battery module of Embodiment 3 of the present invention.

FIG. 7 is a perspective view showing one step of a production method of a battery module according to Embodiment 3 of the present invention.

FIG. 8A is a perspective view of a thin plate battery as viewed from above that is used in a battery module of Embodiment 4 of the present invention.

FIG. 8B is a perspective view of a thin plate battery as viewed from above as shown in FIG. 8A in which the positive electrode tab is folded so as to be substantially L-shaped.

FIG. 9A is a perspective view of another thin plate battery as viewed from above that is used in a battery module of Embodiment 4 of the present invention.

FIG. 9B is a perspective view of a thin plate battery as viewed from above as shown in FIG. 9A in which the negative electrode tab is folded so as to be substantially L-shaped.

FIG. 10 is a plan view of a connecting member provided with a voltage monitoring terminal for use in a battery module of Embodiment 5 of the present invention.

FIG. 11A is a perspective view of thin plate batteries that are arranged on the same plane and connected by the connecting member shown in FIG. 10 of Embodiment 5 of the present invention.

FIG. 11B is a perspective view of thin plate batteries that are arranged on the same plane and connected by the connecting member shown in FIG. 10 of Embodiment 5 of the present invention.

FIGS. 12A and 12B are perspective views of thin plate batteries including positive electrode tabs provided with a voltage monitoring terminal for use in a battery module of Embodiment 5 of the present invention.

FIGS. 13A and 13B are perspective views of thin plate batteries including positive electrode tabs provided with a voltage monitoring terminal for use in a battery module of Embodiment 5 of the present invention.

FIG. 14 is a perspective view showing a step of attaching an output terminal of a battery module of Embodiment 6 of the present invention.

FIG. 15 is an exploded perspective view showing thin plate batteries and cases that accommodate the batteries constituting a battery module of Embodiment 7 of the present invention.

### DETAILED DESCRIPTION OF THE INVENTION

The present invention can provide a battery module that can be easily produced and with which a short circuit accident is unlikely to occur in an electrode tab connecting operation, and a production method therefor.

A battery module of the present invention is a battery module in which a plurality of thin plate batteries having a rectangular shape as viewed from above are placed on top of the other. The plurality of thin plate batteries each have a positive electrode tab and a negative electrode tab extending from a front side. The positive electrode tab and the negative electrode tab of adjacent thin plate batteries face each other. The positive electrode tab and the negative electrode tab that face each other are electrically connected such that the plurality of thin plate batteries are connected in series. An electrically conducting path that electrically connects the positive electrode tab and the negative electrode tab is folded along a folding line that is parallel to a lateral side adjacent to the front side.

In the battery module of the present invention, it is preferable that the positive electrode tab and the negative electrode tab are electrically connected via a connecting member that is a member separate from the positive electrode tab and the negative electrode tab. In this case, it is preferable that the connecting member is folded along the folding line. This configuration allows the battery module of the present invention to be configured with existing thin plate batteries merely by newly providing a connecting member without changing the designs of the positive electrode tab and the negative electrode tab. Therefore, a battery module can be produced inexpensively.

Alternatively, in the battery module of the present invention, the positive electrode tab and the negative electrode tab may be connected directly. In this case, it is preferable that the positive electrode tab or the negative electrode tab is folded along the folded line. Because the positive electrode tab and the negative electrode tab are directly connected, this configuration makes it possible to suppress an increase of the connection resistance of the electrically conducting path. Also, the connecting member is not necessary, and thus the number of components of the battery module can be reduced.

In the battery module of the present invention, it is preferable that the electrically connected positive electrode tab and negative electrode tab are folded along the folding line that is parallel to the front side. This makes it possible to lessen the extent of the electrically conducting path projecting from the front side and thus to reduce the possibility of external force acting on the electrically conducting path or the possibility of a short circuit on the electrically conducting path.

It is preferable that the thin plate battery has a power generating element and an exterior member that accommodates the power generating element. In this case, it is preferable that a region corresponding to the power generating element projects away relative to a region where the exterior member is sealed, thus creating a level difference on one side of the thin plate battery. It is preferable that the positive electrode tab and the negative electrode tab are folded such that at least a part of the electrically conducting path faces a front sealing part that is a region where the exterior member is sealed along the front side and is accommodated in a space created by the level difference. This configuration allows a part of the electrically conducting path to be accommodated in the space created by the level difference, thus making it possible to further reduce the possibility of external force acting on the electrically conducting path or the possibility of a short circuit on the electrically conducting path. Also, this configuration makes it possible to suppress an increase of the thickness of the battery module resulting from the folded positive electrode tab and negative electrode tab.

In the battery module of the present invention, it is preferable that the electrically conducting path does not project more outward than the lateral side of the thin plate battery. This makes it possible to reduce the possibility that the electrically conducting path comes into contact with the inner surface of a housing and results in a short circuit in the case where the battery module is accommodated in the housing.

In the battery module of the present invention, it is preferable that the electrically conducting path is provided with a voltage monitoring terminal. This makes it possible to easily monitor the voltage of each thin plate battery that constitutes the battery module.

In the battery module of the present invention, it is preferable that the plurality of batteries are each accommodated in a case provided with a side plate that covers the lateral side. This makes it possible to provide a battery module that can be more easily produced. Also, this configuration is advantageous in terms of a reduction of the positional shift of the battery module in a housing, heat dissipation, and the like in the case where the battery module is accommodated in a housing.

A production method of a battery module of the present invention includes the successive steps of (a) providing a plurality of thin plate batteries each having a substantially rectangular shape as viewed from above and including a positive electrode tab and a negative electrode tab extending from a front side, (b) arranging the plurality of thin plate batteries on the same plane such that the front sides of the plurality of thin plate batteries form a straight line and such that the positive electrode tab and the negative electrode tab of the plurality of thin plate batteries are alternately disposed in a direction parallel to the front sides, (c) electrically connecting the positive electrode tab and the negative electrode tab between adjacent thin plate batteries such that the plurality of thin plate batteries are connected in series, and (d) placing the adjacent thin plate batteries one on top of the other by folding an electrically conducting path that electrically connects the positive electrode tab and the negative electrode tab along a folding line that is parallel to lateral sides adjacent to the front sides.

In the step (c), it is preferable that the positive electrode tab and the negative electrode tab are electrically connected via a connecting member that is a member separate from the positive electrode tab and the negative electrode tab. This configuration allows the battery module of the present invention to be configured with existing thin plate batteries merely by newly providing a connecting member without changing the designs of the positive electrode tab and the negative electrode tab. Therefore, a battery module can be produced inexpensively.

Alternatively, it is preferable that one of the positive electrode tab and the negative electrode tab is substantially L-shaped. In this case, it is preferable in the step (c) that one of the positive electrode tab and the negative electrode tab that is substantially L-shaped is directly connected to the other. Because the positive electrode tab and the negative electrode tab are directly connected, this configuration makes it possible to suppress an increase of the connection resistance of the electrically conducting path. Also, the connecting member is not necessary, and thus the number of components of the battery module can be reduced.

Alternatively, the method of the present invention may further include the step (e) of folding one of the positive electrode tab and the negative electrode tab so as to be substantially L-shaped. In this case, it is preferable in the step (c) that one of the positive electrode tab and the negative electrode tab that is folded so as to be substantially L-shaped is directly connected to the other. Because the positive electrode tab and the negative electrode tab are directly connected, this configuration makes it possible to suppress an increase of the connection resistance of the electrically conducting path. Also, the connecting member is not necessary, and thus the number of components of the battery module can be reduced. Moreover, a positive electrode tab and a negative electrode tab that have a simple strip shape serve sufficiently, and thus the positive electrode tab and the negative electrode tab can be easily produced and are advantageous in terms of cost reduction.

It is preferable that the method of the present invention further includes the step (f) of folding the positive electrode tab and the negative electrode tab that are electrically connected in the step (c) along a folding line that is parallel to the front side. This makes it possible to lessen the extent of the electrically conducting path projecting from the front side and thus to reduce the possibility of external force acting on the electrically conducting path or the possibility of a short circuit on the electrically conducting path in the eventually obtained battery module.

The step (f) may be carried out before the electrically conducting path is folded, or the step (f) may be carried out after the electrically conducting path is folded.

It is preferable that the method of the present invention further includes the step (g) of attaching output terminals to the positive electrode tab and the negative electrode tab, among the positive electrode tabs and the negative electrode tabs of the plurality of thin plate batteries, that are not electrically connected to tabs that have different polarities in the step (c). In this case, it is preferable to carry out the step (g) simultaneously with the step (c). This makes it possible to efficiently attach the output terminals while reducing the possibility of a short circuit accident.

It is preferable that the method of the present invention further includes the step (h) of accommodating the thin plate batteries in cases provided with side plates that cover the lateral sides of the thin plate batteries. In this case, it is preferable to carry out the step (h) between the step (a) and the step (c). This allows the batteries in the state of being accommodated in the cases to be handled in the battery module production process, thus making it possible to further simplify the battery module production.

Below, the present invention will be described in detail while disclosing preferred embodiments. However, it goes without saying that the present invention is not limited to the following embodiments. For the sake of convenience in the description, the drawings that are referenced in the following description show simplifications of, among the constituent members of the embodiments of the present invention, only relevant members that are necessary for describing the present invention. The present invention can therefore include arbitrary members that are not shown in the following drawings. Also, regarding the dimensions of the members in the drawings, the dimensions of the actual members, the ratios of the dimensions of the members, and the like are not shown faithfully.

### Configuration of Thin Plate Battery

First, a schematic configuration of the thin plate battery (hereinafter simply referred to as a “battery”) for use in the battery module of the present invention will now be described.

The battery of the present invention is substantially rectangular as viewed from above, and has a thin plate shape with the thickness being smaller than the length and width of the rectangle. A positive electrode tab and a negative electrode tab through which electricity is extracted extend from one side (usually a shorter side) of the four sides that form the outer edge of the rectangle. The battery type is not particularly limited, and a secondary battery, in particular a lithium-ion secondary battery, is preferable. In the following description, the battery of the present invention is described using as an example a laminated lithium-ion secondary battery in which the power generating element is covered with a flexible sheet.

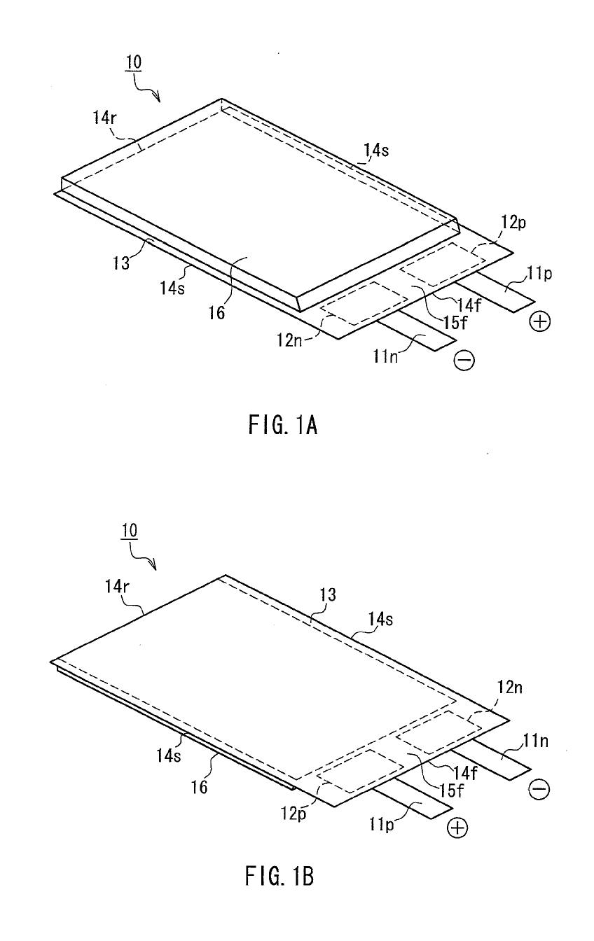

FIG. 1A is a perspective view of a three-side-sealed battery 10 as viewed from above, and FIG. 1B is a perspective view thereof as viewed from below. In the battery 10, a power generating element in a thin plate form (not shown) having a substantially rectangular shape as viewed from above is sealed together with an electrolyte in an exterior member composed of a laminate sheet 13. The power generating element is an electrode laminate in which a positive electrode in which a positive electrode mixture layer containing a positive electrode active material is applied to and formed on both sides of a predetermined region of a positive electrode current collector, a negative electrode in which a negative electrode mixture layer containing a negative electrode active material is applied to and formed on both sides of a predetermined region of a positive electrode current collector are stacked alternately via a separator. The laminate sheet 13 is a flexible multilayer sheet in which a thermally adhering resin layer (for example, a modified polyolefin layer) is laminated on the surface on the side facing the power generating element of a substrate composed of aluminum or the like. One piece of the rectangular laminate sheet 13 is folded over along a rear side (one of the shorter sides) 14r such that the power generating element is sandwiched therebetween, so that the three-sides of the folded-over portion meet the three-sides of the underlying portion other than the rear side 14r, and sealed by a heat seal method.

A positive electrode tab 11p and a negative electrode tab 11n extend from a front side (the other shorter side) 14f located opposite the rear side 14r. The positive electrode tab 11p and the negative electrode tab 11n each have a strip shape, and extend in the direction perpendicular to the front side 14f (i.e., a direction parallel to a pair of lateral sides (longer sides) 14s adjacent to the front side). The positive electrode tab 11p is composed of, for example, a thin plate of aluminium and is welded at a positive electrode welding part 12p to a positive electrode current collector (not shown) that constitutes the power generating element. The negative electrode tab 11n is composed of, for example, a thin plate of copper, a thin plate of nickel-plated copper, a copper/nickel clad material, or the like, and is welded at a negative electrode welding part 12n to a negative electrode current collector (not shown) that constitutes the power generating element. The positive electrode welding part 12p and the negative electrode welding part 12n are sandwiched by the folded laminate sheet 13, and sealed at a front sealing part 15f that is a region in which the laminate sheet 13 is sealed along the front side 14f.

The laminate sheet 13 is thinner than the power generating element and is flexible. Therefore, as shown in FIG. 1A, on the surface on one side of the battery 10, a rectangular region 16 that corresponds to the power generating element projects away relative to a sealing region of the laminate sheet 13 that is provided along the three sides 14f, 14s, and 14s of the battery 10 except for the rear side 14r, thus creating a level difference between the projecting region 16 and the sealing region. On the other hand, as shown in FIG. 1B, the surface on the other side of the battery 10 is substantially flat. Herein, for convenience of description, the surface on which the rectangular projecting region 16 is created due to the power generating element shown in FIG. 1A is referred to as the “upper surface” of the battery 10, and the surface on the side that is substantially flat shown in FIG. 1B is referred to as the “lower surface” of the battery 10. Also, the upper surface side is referred to as the “upper side” of the battery 10, and the lower surface side is referred to as the “lower side” of the battery 10. The direction perpendicular to the upper surface and the lower surface of the battery 10 is referred to as the “thickness direction” of the battery 10. Note that the terms “upper” and “lower” do not necessarily indicate the vertical relationship when the battery 10 is actually used.

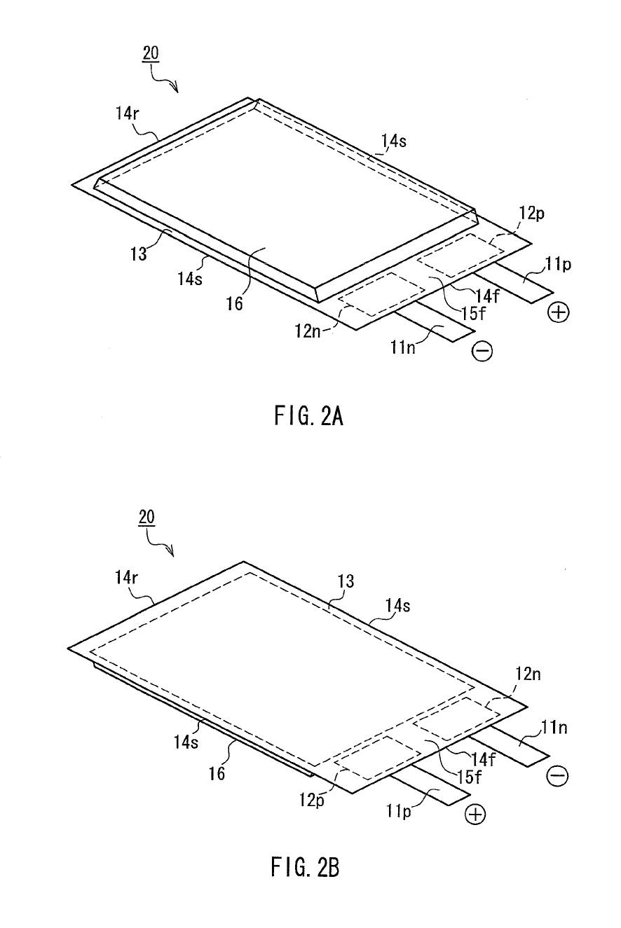

FIG. 2A is a perspective view of a four-side-sealed thin plate battery 20 as viewed from above, and FIG. 2B is a perspective view thereof as viewed from below. The battery 20 has an exterior member that is configured with two pieces of a laminate sheet, thus being different from the battery 10 shown in FIGS. 1A and 1B that has an exterior member configured with a single piece of a laminate sheet. That is, as can be easily understood by comparing FIG. 2A with FIG. 1A, in the battery 20, the power generating element is sandwiched between two rectangular laminate sheets 13, so that the four sides including the rear side 14r of the two laminate sheets 13 meet and are sealed by a heat seal method. Therefore, as shown in FIG. 2A, on the upper surface of the battery 20, the rectangular region 16 corresponding to the power generating element projects away relative to the sealing region that is provided along the four sides 14f, 14s, 14s, and 14r of the battery 20. Other than the configuration of the exterior member, the battery 20 of FIGS. 2A and 2B is identical to the battery 10 of FIGS. 1A and 1B. In FIGS. 2A and 2B, the same components as in FIGS. 1A and 2B are given the same reference characters, and descriptions thereof are omitted.

### Embodiment 1

A production method of a battery module 1 of Embodiment 1 in which three batteries 10 shown in FIGS. 1A and 1B are placed one on top of the other will now be described. In the following description, when the three batteries and the constituent members thereof need to be distinguished, characters “a”, “b”, and “c” are added to their reference characters.

First, three batteries 10 shown in FIGS. 1A and 1B (regarded as batteries 10a, 10b, and 10c) are provided.

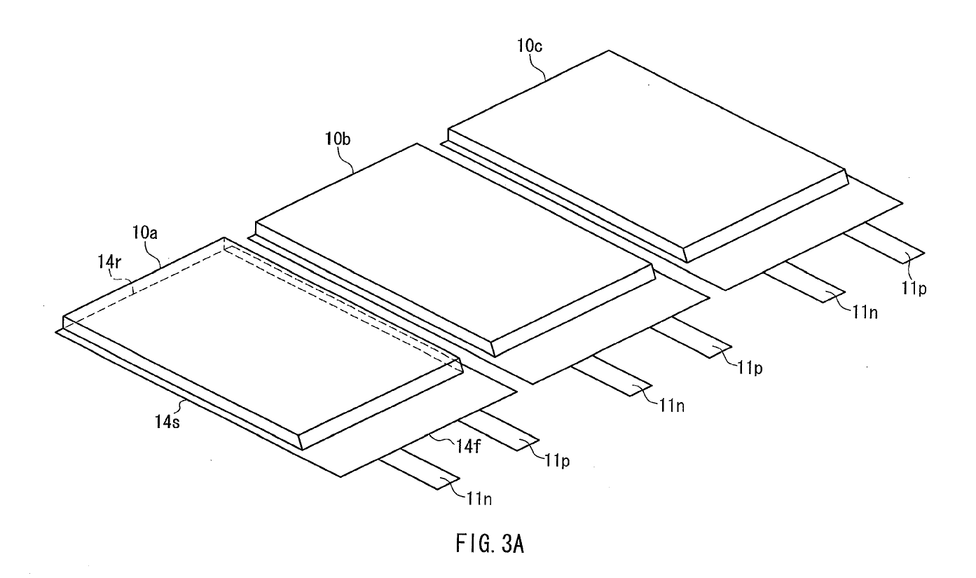

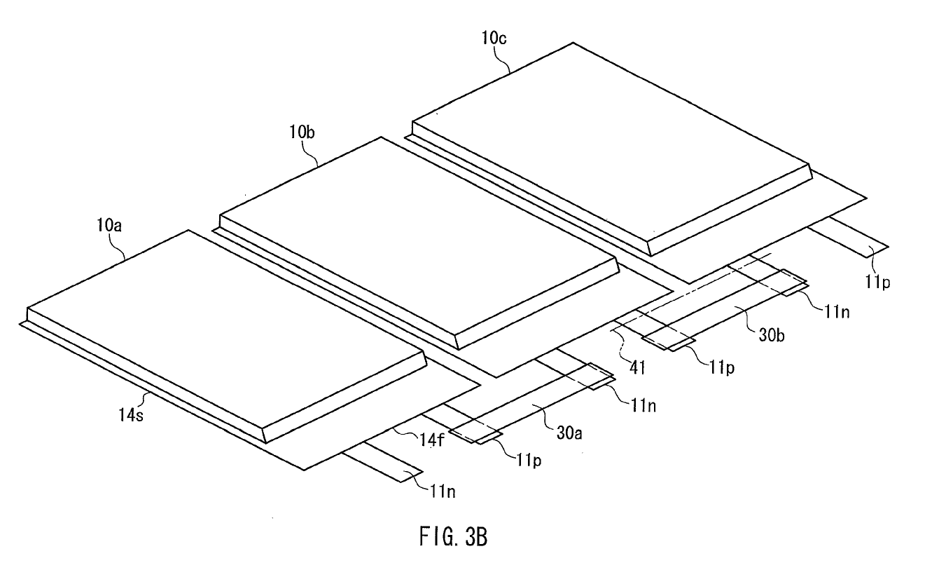

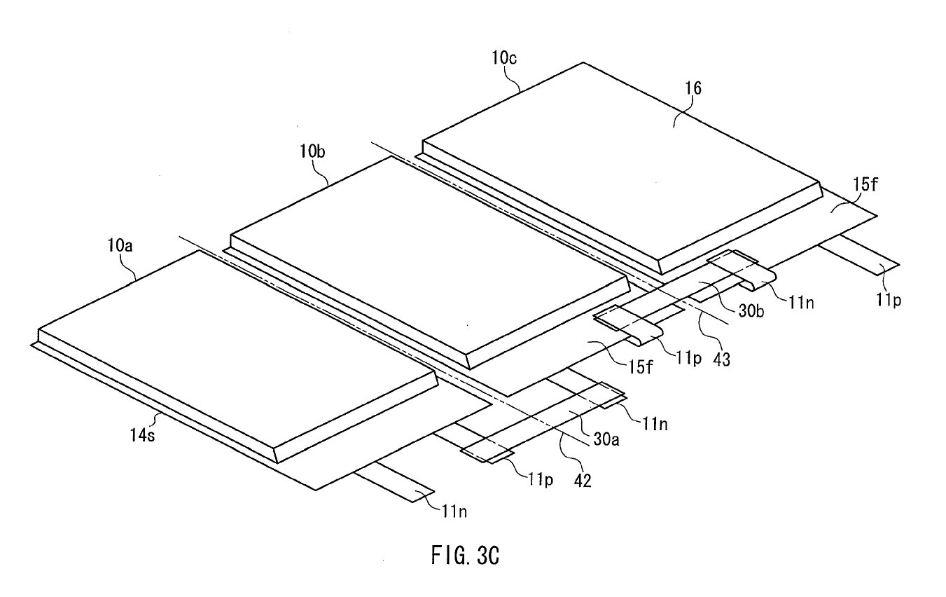

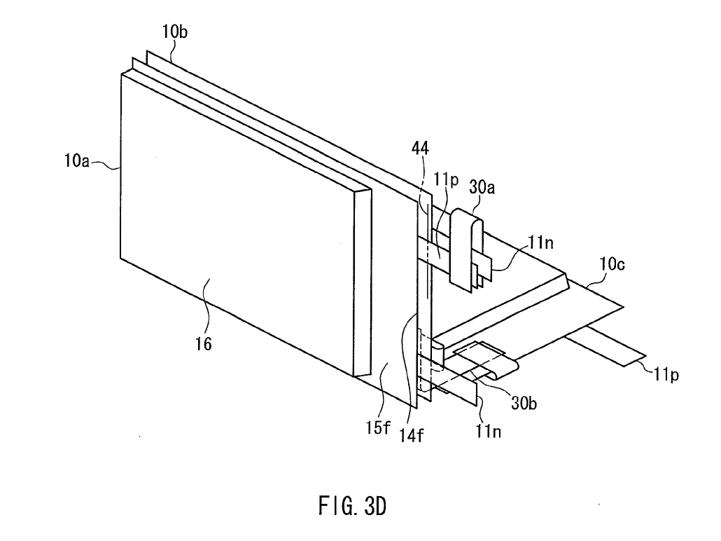

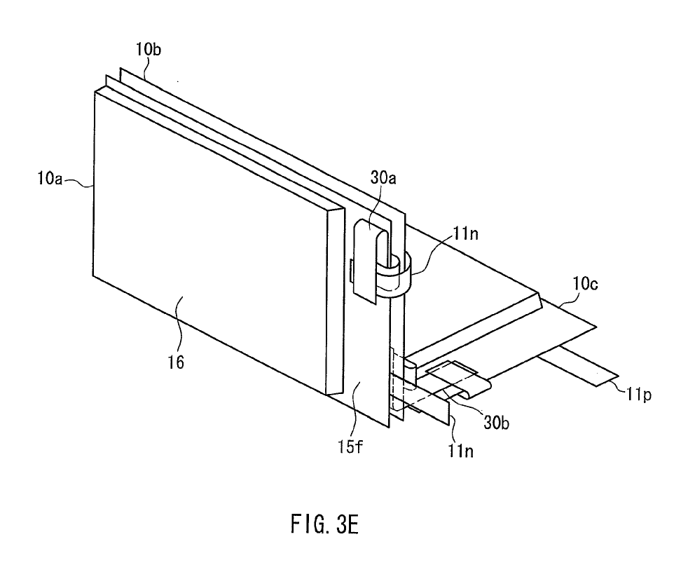

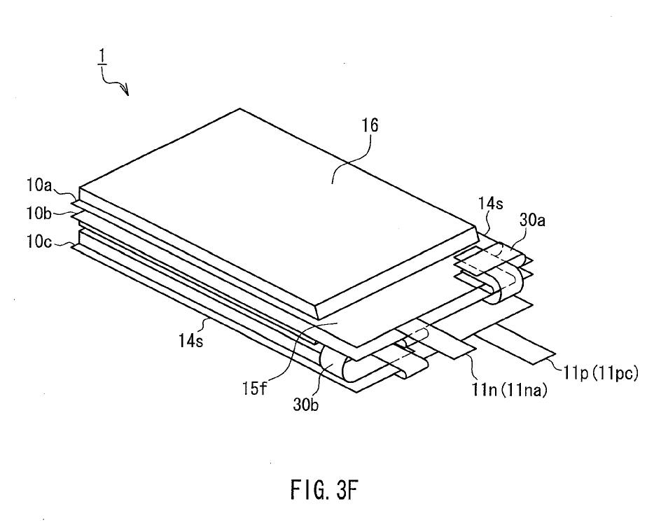

Next, as shown in FIG. 3A, the three batteries 10a, 10b, and 10c are arranged on the same plane, with their upper surfaces facing above, such that the front sides 14f from which the positive electrode tabs 11p and the negative electrode tabs 11n extend and the rear sides 14r on the opposite side are arranged along respective straight lines. As a result, the negative electrode tabs 11n and the positive electrode tabs 11p are alternately arranged in the direction of the arrangement of the three batteries 10a, 10b, and 10c. It is preferable to connect adjacent batteries with adhesive tape (not shown) or the like so as not to allow the batteries to be separated from each other. For example, adhesive tape may be applied to adjacent batteries along the lateral sides 14s of the adjacent batteries such that the adhesive tape bridges the gap between the adjacent batteries, or adhesive tapes may be applied continuously across the three batteries 10a, 10b, and 10c along the front sides 14f and the rear sides 14r.

Next, as shown in FIG. 3B, the mutually adjacent negative electrode tab 11n and positive electrode tab 11p between adjacent batteries are electrically connected. That is, the positive electrode tab 11p of the battery 10a and the negative electrode tab 11n of the battery 10b are connected, and the positive electrode tab 11p of the battery 10b and the negative electrode tab 11n of the battery 10c are connected. As a result, the three batteries 10a, 10b, and 10c are connected in series.

The manner of connecting the adjacent positive electrode tabs 11p and negative electrode tabs 11n is not particularly limited, and in Embodiment 1, as shown in FIG. 3B, an electrically conducting path is formed between the positive electrode tabs 11p and the negative electrode tabs 11n by placing strip-shaped connecting members 30a and 30b between the positive electrode tabs 11p and the negative electrode tabs 11n. The manner of connecting the connecting members 30a and 30b to the electrode tabs 11n and 11p is not particularly limited, and for example, various methods such as ultrasonic welding, resistance welding, laser welding, crimping, and adhesion by an electroconductive adhesive can be used.

The materials of the connecting members 30a and 30b can be selected according to the materials of the electrode tabs 11n and 11p connected therewith, the manner of connection with the electrode tabs 11n and 11p, and the like. For example, a two-layer laminated clad material of copper/aluminium can be used for the connecting members 30a and 30b.

As shown in FIG. 3B, the strip-shaped connecting members 30a and 30b are placed so as to form bridges on the tips of the adjacent positive electrode tabs 11p and negative electrode tabs 11n to connect the connecting members 30a and 30b with the electrode tabs 11n and 11p. The places of connection of the connecting members 30a and 30b with the electrode tabs 11n and 11p are cyclically arranged along a straight line on the same plane, thus making it easy to automate the connecting operation. For example, welding can be continuously performed in the direction in which the batteries 10a, 10b, and 10c are arranged using a roller ultrasonic welder, and this method can perform all connection operations in an extremely short period of time. Of course, the connection of the connecting members 30a and 30b with the electrode tabs 11n and 11p may be manually performed in a sequential manner. Either way, because the places of connection of the connecting members 30a and 30b with the electrode tabs 11n and 11p are arranged along a straight line on the same plane, a risk of a short circuit accident that is caused by an accidental contact of a connecting tool with an electrode tab that is not intended to be connected is extremely low when an electrode tab and a connecting member are connected.

Next, the positive electrode tab 11p and the negative electrode tab 11n to which the connecting member 30b is connected are valley-folded along a dashed double-dotted line 41 of FIG. 3B that is parallel to the front sides 14f to place the connecting member 30b over the front sealing parts 15f (see FIG. 1A) of the batteries 10b and 10c as shown in FIG. 3C. The connecting member 30b and the portions of the positive electrode tab 11p and the negative electrode tab 11n connected thereto are accommodated within the level difference created with the front sealing parts 15f and the projecting regions 16 of the batteries 10b and 10c.

Next, in connection with FIG. 3C, the connecting member 30a is mountain-folded along a dashed double-dotted line 42 between the batteries 10a and 10b such that the batteries 10a and 10b are placed one on top of the other with the lower surfaces thereof facing each other, and the connecting member 30b is valley-folded along a dashed double-dotted line 43 between the batteries 10b and 10c such that the batteries 10b and 10c are placed one on top of the other with the upper surfaces thereof facing each other. The dashed double-dotted lines 42 and 43 are parallel to the lateral sides 14s of the batteries 10a, 10b, and 10c.

FIG. 3D shows a state immediately before the batteries 10a and 10b that have been placed one on top of the other are placed on top of the battery 10c. The connecting member 30a that connects between the batteries 10a and 10b is folded in half, and the positive electrode tab 11p of the battery 10a and the negative electrode tab 11n of the battery 10b to which the connecting member 30a is connected face each other. The positive electrode tab 11p and the negative electrode tab 11n to which the connecting member 30a is connected are valley-folded along a dashed double-dotted line 44 that is parallel to the front side 14f to place the connecting member 30a that is folded in half over the front sealing part 15f (see FIG. Lk) of the battery 10a as shown in FIG. 3E. The connecting member 30a and the portions of the positive electrode tab 11p and the negative electrode tab 11n connected thereto are accommodated within the level difference created with the front sealing part 15f and the projecting region 16. Moreover, the batteries 10a and 10b that have been placed one on top of the other are placed on top of the battery 10c. Thus, the battery module 1 of Embodiment 1 as shown in FIG. 3F is obtained. The connecting member 30b that connects between the batteries 10b and 10c is folded in half and the positive electrode tab 11p of the battery 10b and the negative electrode tab 11n of the battery 10c to which the connecting member 30b is connected face each other.

In the production method of the battery module 1, the positive electrode tab 11p and the negative electrode tab 11n may be folded along the dashed double-dotted line 44 (see FIG. 3D) after the batteries 10a and 10b that have been placed one on top of the other are placed on top of the battery 10c. Also, after the batteries 10b and 10c are placed one on top of the other by folding the connecting member 30b in half along the dashed double-dotted line 43 (see FIG. 3C), the batteries 10b and 10c that have been placed one on top of the other may be placed on top of the battery 10a.

As described above, according to the production method of the battery module 1 of Embodiment 1, as shown in FIG. 3B, all the batteries that constitute the battery module 1 are connected in series in a state of being arranged along a straight line on the same plane. Therefore, the step of connecting the electrode tabs is easy, does not require skill, and can be easily automated. Also, the risk of a short circuit accident is small.

After all the batteries are connected in series, the batteries are sequentially placed one on top of the other. Because adjacent batteries are already connected, the step of placing the batteries one on top the other is also easy, and can be carried out in a short period of time.

Therefore, Embodiment 1 makes it possible to safely and efficiently produce a battery module.

The battery module 1 shown in FIG. 3F includes the three batteries 10a, 10b, and 10c that are connected in series. Through the electrode tabs at the respective ends of the battery module 1, i.e., the negative electrode tab 11n (11na) of the battery 10a and the positive electrode tab 11p (11pc) of the battery 10c, charge and discharge can be performed on the battery module 1.

The positive electrode tabs 11p and the negative electrode tabs 11n that are connected to the connecting members 30a and 30b are folded such that the connecting members 30a and 30b are placed over the front sealing parts 15f of the batteries. Therefore, as shown in FIG. 3F, only the positive electrode tab 11pc and the negative electrode tab 11na to which the connecting members 30a and 30b are not connected largely project from the front sides 14f farther than the other positive electrode tabs 11p and negative electrode tabs 11n. Therefore, even when an impact or vibrations are applied to the battery module 1 in a state of being accommodated in a housing (i.e., a container that accommodates the battery module 1), it is unlikely that the connecting members 30a and 30b and the positive electrode tabs 11p and the negative electrode tabs 11n that are connected thereto hit the inner surface of the housing, and receive such external force. Thereby, a possibility that the connecting members 30a and 30b and the electrode tabs 11p and 11n deform or short-circuit is reduced. Also, the operation of connecting wiring to the negative electrode tab 11na of the battery 10a and the positive electrode tab 11pc of the battery 10c that serve as input/output terminals of the battery module 1 in the FIG. 3F state is easy, and also a possibility that the wiring and the connecting members 30a and 30b short-circuit during this operation is reduced.

The connecting members 30a and 30b are accommodated within the level differences created with the projecting regions 16 on the upper surface sides of the batteries and the front sealing parts 15f. Therefore, even when the connecting members 30a and 30b are placed over the front sealing parts 15f, the connecting members 30a and 30b do not project higher than the projecting regions 16, or the thickness of the battery module 1 does not increase.

The connecting members 30a and 30b folded in half do not project more outward than the respective lateral sides 14s of the batteries 10a, 10b, and 10c. Also, as described above, the connecting member 30a does not project higher than the projecting region 16 of the battery 10a. Therefore, in the case where the battery module 1 is accommodated in a housing that has an inner surface composed of a conductive material such as metal, the connecting members 30a and 30b do not contact the inner surface of the housing, thus making it possible to prevent a short circuit.

In the description above, the battery module 1 that is composed of the three batteries 10a, 10b, and 10c has been described, but the number of batteries 10 that constitute the battery module 1 of Embodiment 1 is not limited to three, and may be four or greater. Regardless of the number of batteries 10, as shown in FIG. 3A, n batteries (n is an integer of three or greater) 10a, 10b, 10c, and so on up to 10n are arranged on the same plane such that the front sides 14 form a straight line, and the positive electrode tabs 11p and the negative electrode tabs 11n are alternately disposed. Next, as shown in FIG. 3B, the positive electrode tabs 11p and the negative electrode tabs 11n of adjacent batteries 10 are connected via n-1 connecting members (connecting members 30a, 30b, and so on up to 30n-1). Next, as shown in FIG. 3C, the positive electrode tabs 11p and the negative electrode tabs 11n that are connected to every other connecting member (even-numbered connecting members) are folded such that the every other connecting member is placed over the front sealing parts 15f. Next, as shown in FIGS. 3D to 3F, adjacent batteries are placed one on top of the other such that, among the plurality of connecting members, the connecting members (even-numbered connecting members) placed over the front sealing parts 15f as in FIG. 3C are valley-folded, and the other connecting members (odd-numbered connecting members) are mountain-folded. Moreover, the positive electrode tabs 11p and the negative electrode tabs 11n connected to the odd-numbered connecting members are folded such that the odd-numbered connecting members that are folded in half as shown in FIG. 3E are placed over the front sealing parts 15f. It is thus possible to obtain the battery module 1 of Embodiment 1 in which n batteries 10 that are connected in series and placed one on top of the other.

In the description above, as shown in FIGS. 3C and 3E, the positive electrode tabs 11p and the negative electrode tabs 11n that are connected to the connecting members are folded such that the connecting members are placed over the front sealing parts 15f, but the step of folding the positive electrode tabs 11p and the negative electrode tabs 11n may be omitted in the present invention. In the battery module 1 obtained in such a manner, the connecting members project outward from the front sides 14f of the batteries 10 as with the negative electrode tab 11na and the positive electrode tab 11pc at the respective ends of the battery module 1.

### Embodiment 2

A production method for a battery module 2 of Embodiment 2 in which the three batteries 10 shown in FIGS. 1A and 1B will now be described, mainly focusing on the difference from Embodiment 1. In the following description, when the three batteries and the constituent members thereof need to be distinguished, characters “a”, “b”, and “c” are added to their reference characters.

First, the three batteries 10 shown in FIGS. 1A and 1B (regarded as batteries 10a, 10b, and 10e) are provided.

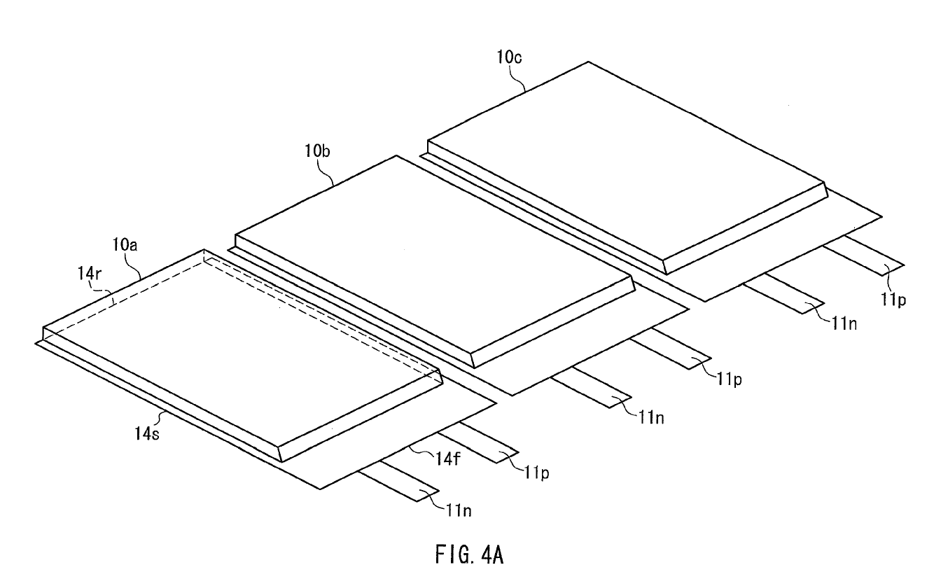

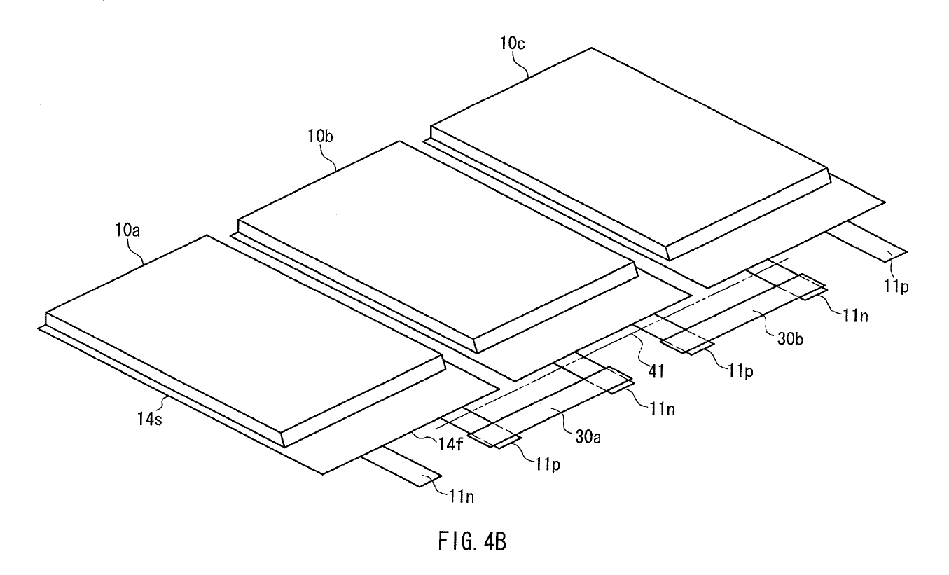

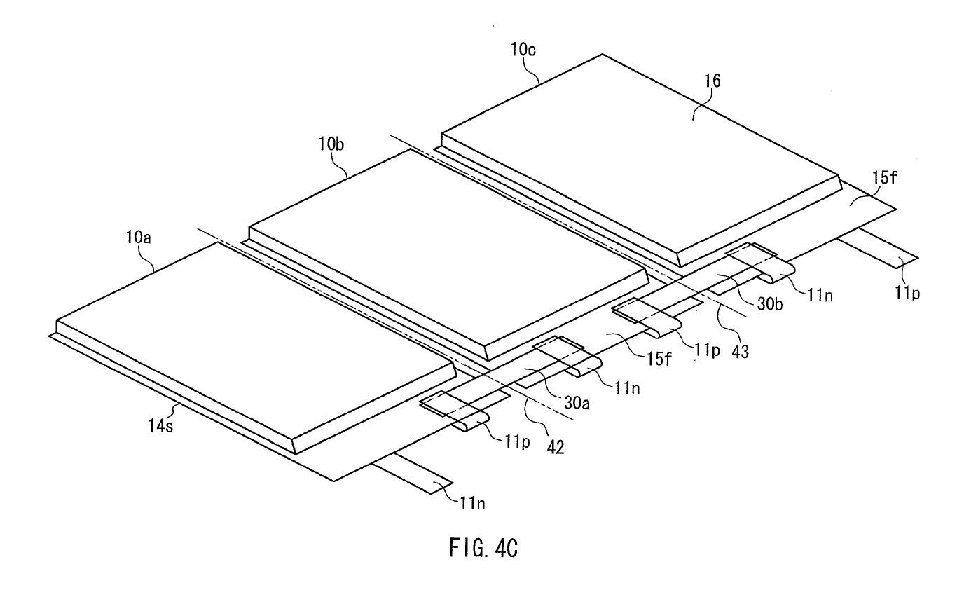

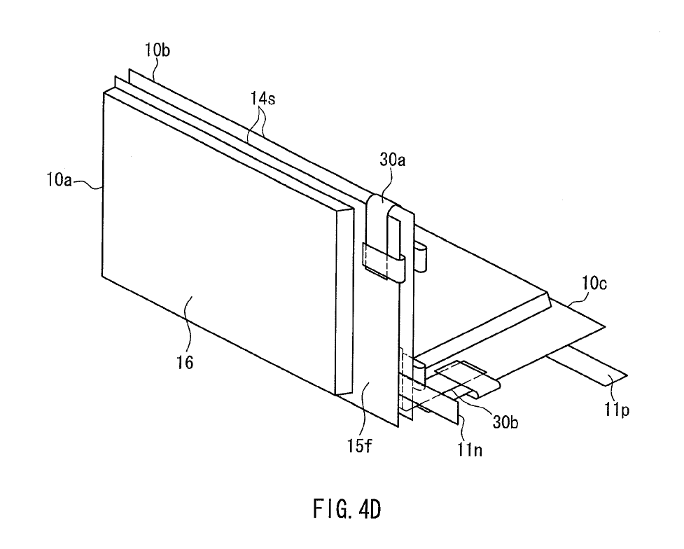

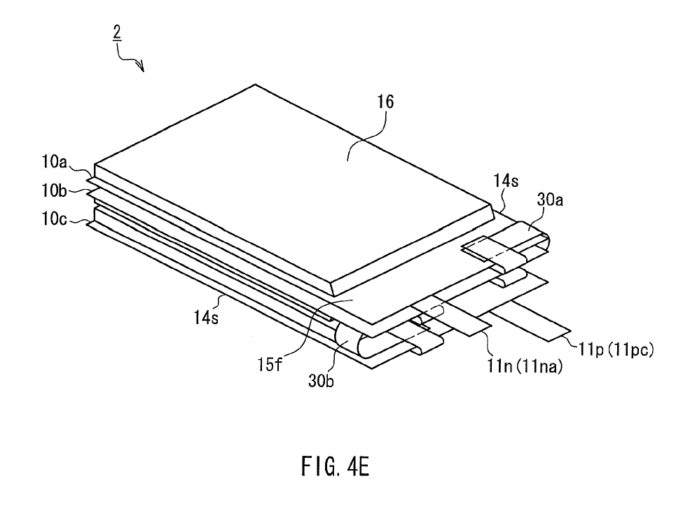

Next, as shown in FIG. 4A, the three batteries 10a, 10b, and 10c are arranged on the same plane, with their upper surfaces facing above, such that the front sides 14f from which the positive electrode tabs 11p and the negative electrode tabs 11n extend and the rear sides 14r on the opposite side are arranged along respective straight lines. This step is identical to FIG. 3A of Embodiment 1. The description on FIG. 3A of Embodiment 1 is similarly applicable to Embodiment 2.

Next, as shown in FIG. 4B, the mutually adjacent negative electrode tabs 11n and positive electrode tabs 11p between adjacent batteries are electrically connected with the connecting members 30a and 30b to connect the three batteries 10a, 10b, and 10c in series. This step is identical to FIG. 3B of Embodiment 1. The description on FIG. 3B of Embodiment 1 is similarly applicable to Embodiment 2.

Next, the positive electrode tabs 11p and the negative electrode tabs 11n to which the connecting members 30a and 30b are connected are valley-folded along the dashed double-dotted line 41 of FIG. 4B that is parallel to the front sides 14f to place the connecting members 30a and 30b over the front sealing parts 15f (see FIG. 1A) of the batteries 10a, 10b, and 10c as shown in FIG. 4C. The connecting members 30a and 30b and the portions of the positive electrode tabs 11p and the negative electrode tabs 11n connected thereto are accommodated within the level differences created with the front sealing parts 15f and the projecting regions 16. While only the connecting member 30b is placed over the front sealing parts 15f in Embodiment 1 as shown in FIG. 3C, in Embodiment 2 all the connecting members 30a and 30b are placed over the front sealing parts 15f as shown in FIG. 4C.

Next, in connection with FIG. 4C, the connecting member 30a is mountain-folded along the dashed double-dotted line 42 between the batteries 10a and 10b such that the batteries 10a and 10b are placed one on top of the other with the lower surfaces thereof facing each other, and the connecting member 30b is valley-folded along the dashed double-dotted line 43 between the batteries 10b and 10c such that the batteries 10b and 10c are placed one on top of the other with the upper surfaces thereof facing each other. The dashed double-dotted lines 42 and 43 are parallel to the lateral sides 14s of the batteries 10a, 10b, and 10c.

FIG. 4D shows a state immediately before the batteries 10a and 10b that have been placed one on top of the other are placed on top of the battery 10c. The connecting member 30a that connects between the batteries 10a and 10b is folded in half, and the positive electrode tab 11p of the battery 10a and the negative electrode tab 11n of the battery 10b to which the connecting member 30a is connected face each other. As can be easily understood by comparing FIG. 4D with FIG. 3D that shows Embodiment 1, the connecting member 30a that is folded in half partially covers the lateral sides 14s of the batteries 10a and 10b. Moreover, the batteries 10a and 10b that have been placed one on top of the other are placed on top of the battery 10c. Thus, the battery module 2 of Embodiment 2 as shown in FIG. 4E is obtained. The connecting member 30b that connects between the batteries 10b and 10c is folded in half, and the positive electrode tab 11p of the battery 10b and the negative electrode tab 11n of the battery 10c to which the connecting member 30b is connected face each other.

In the production method of the battery module 2, after the batteries 10b and 10c are placed one on top of the other by folding the connecting member 30b in half along the dashed double-dotted line 43 (see FIG. 4C), the batteries 10b and 10c that have been placed one on top of the other may be placed on top of the battery 10a.

As described above, according to the production method of the battery module 2 of Embodiment 2, as shown in FIG. 4B, all the batteries that constitute the battery module 2 are connected in series in a state of being arranged along a straight line on the same plane. Therefore, the step of connecting the electrode tabs is easy, does not require skill, and can be easily automated. Also, the risk of a short circuit accident is small.

After all the batteries are connected in series, the batteries are sequentially placed one on top of the other. Because adjacent batteries are already connected, the step of placing the batteries one on top the other is also easy, and can be carried out in a short period of time.

Therefore, as with Embodiment 1, Embodiment 2 makes it possible to safely and efficiently produce a battery module.

In Embodiment 2, as shown in FIG. 4C, the positive electrode tabs 11p and the negative electrode tabs 11n that are connected to the connecting members 30a and 30b are folded such that all the connecting members 30a and 30b are placed over the front sealing parts 15f. Therefore, a battery module can be even more efficiently produced than in Embodiment 1.

As with the battery module 1 of Embodiment 1 (see FIG. 3F), the battery module 2 shown in FIG. 4E includes the three batteries 10a, 10b, and 10c that are connected in series. Through the electrode tabs at the respective ends of the battery module 2, i.e., the negative electrode tab 11n (11na) of the battery 10a and the positive electrode tab 11p (11 pc) of the battery 10c, charge and discharge can be performed on the battery module 2.

As with the battery module 1 of Embodiment 1 (see FIG. 3F), the positive electrode tabs 11p and the negative electrode tabs 11n that are connected to the connecting members 30a and 30b are folded such that the connecting members 30a and 30b are placed over the front sealing parts 15f of the batteries. Therefore, even when an impact or vibrations are applied to the battery module 2 in a state of being accommodated in a housing, it is unlikely that the connecting members 30a and 30b and the positive electrode tabs 11p and the negative electrode tabs 11n that are connected thereto hit the inner surface of the housing, and receive such external force. Thereby, a possibility that the connecting members 30a and 30b and the electrode tabs 11p and 11n deform or short-circuit is reduced. Also, the operation of connecting wiring to the negative electrode tab 11na of the battery 10a and the positive electrode tab 11pc of the battery 10c that serve as input/output terminals of the battery module 2 in the FIG. 4F state is easy, and also a possibility that the wiring and the connecting members 30a and 30b short-circuit during this operation is reduced.

As with the battery module 1 of Embodiment 1 (see FIG. 3F), the connecting members 30a and 30b are accommodated within the level differences created with the projecting regions 16 on the upper surface sides of the batteries and the front sealing parts 15f. Therefore, even when the connecting members 30a and 30b are placed over the front sealing parts 15f, the connecting members 30a and 30b do not project higher than the projecting regions 16, or the thickness of the battery module 2 does not increase.

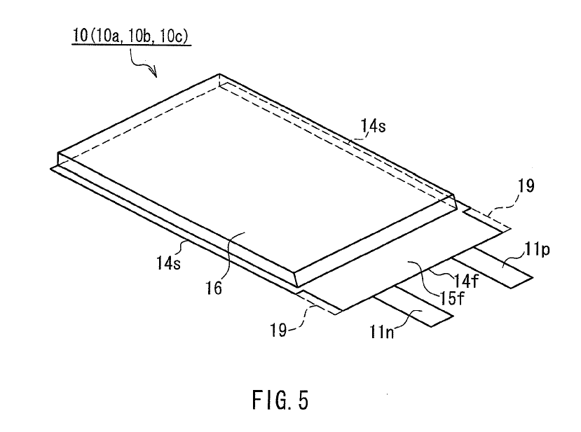

Unlike in the battery module 1 of Embodiment 1, in the battery module 1 of Embodiment 2, the mountain-folded connecting member 30a partially covers the lateral sides 14s of the batteries 10a and 10b as described with reference to FIG. 4D. Therefore, in the case where the battery module 2 is accommodated in a housing that has an inner surface composed of a conductive material such as metal, there is a possibility that the connecting member 30a comes into contact with the inner surface of the housing and results in a short circuit. In order to avoid this, for example, as shown in FIG. 5, a portion 19 of the lateral side 14s of the exterior member covered with the connecting member 30a may be notched to such an extent that the sealing properties of the exterior member is not adversely affected. The mountain-folded connecting member 30a is accommodated in this notch 19, thus making it possible to reduce the possibility that the connecting member 30a comes into contact with the inner surface of the housing and results in a short circuit.

In the description above, the battery module 2 that is composed of the three batteries 10a, 10b, and 10c has been described, but the number of batteries 10 that constitute the battery module 2 of Embodiment 2 is not limited to three, and may be four or greater. Regardless of the number of batteries 10, as shown in FIG. 4A, n batteries (n is an integer of three or greater) 10a, 10b, 10c, and so on up to 10n are arranged on the same plane such that the front sides 14 form a straight line, and the positive electrode tabs 11p and the negative electrode tabs 11n are alternately disposed. Next, as shown in FIG. 4B, the positive electrode tabs 11p and the negative electrode tabs 11n of adjacent batteries 10 are connected via n-1 connecting members (connecting members 30a, 30b, and so on up to 30n-1). Next, as shown in FIG. 4C, the positive electrode tabs 11p and the negative electrode tabs 11n that are connected to the connecting members are folded such that all connecting members are placed over the front sealing parts 15f. Next, as shown in FIGS. 4D and 4E, adjacent batteries are placed one on top of the other such that a plurality of connecting members are alternately valley-folded and mountain-folded (i.e., the odd-numbered connecting members are mountain-folded, and the even-numbered connecting members are valley-folded). It is thus possible to obtain the battery module 2 of Embodiment 2 in which n batteries 10 that are connected in series and placed one on top of the other.

In the description above, as shown in FIG. 4C, the positive electrode tabs 11p and the negative electrode tabs 11n that are connected to the connecting members are folded such that the connecting members are placed over the front sealing parts 15f, but the step of folding the positive electrode tabs 11p and the negative electrode tabs 11n may be omitted in the present invention. In the battery module 2 obtained in such a manner, the connecting members project outward from the front sides 14f of the batteries 10 as with the negative electrode tab 11na and the positive electrode tab 11pc at the respective ends of the battery module 2.

### Embodiment 3

In Embodiments 1 and 2 described above, a connecting member is used to electrically connect adjacent batteries 10. On the other hand, in Embodiment 3, adjacent batteries are electrically connected without a connecting member.

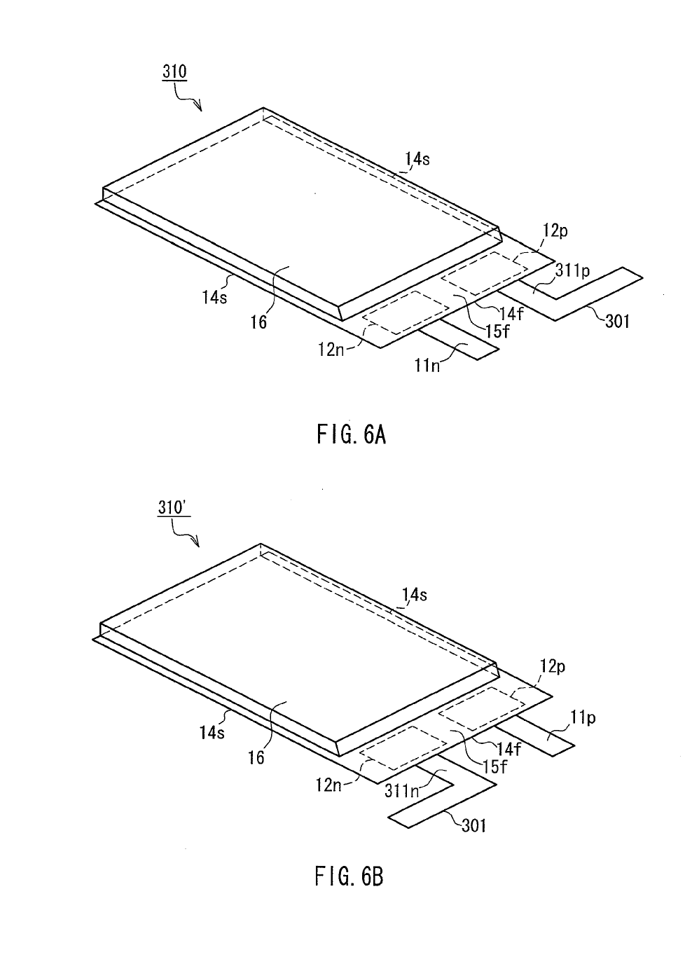

FIG. 6A is a perspective view of a battery 310 as viewed from above that is used in a battery module of Embodiment 3 of the present invention. A positive electrode tab 311p of the battery 310 has on its tip a bridging part 301 extending substantially in parallel with the front side 14f, and as a whole, is substantially L-shaped as viewed from above. The bridging part 301 projects more outward than the lateral side 14s that is closer to the positive electrode tab 311p. In Embodiment 3, the battery 310 of FIG. 6A is used in place of the batteries 10a and 10b shown in FIG. 3A of Embodiment 1 and FIG. 4A of Embodiment 2.

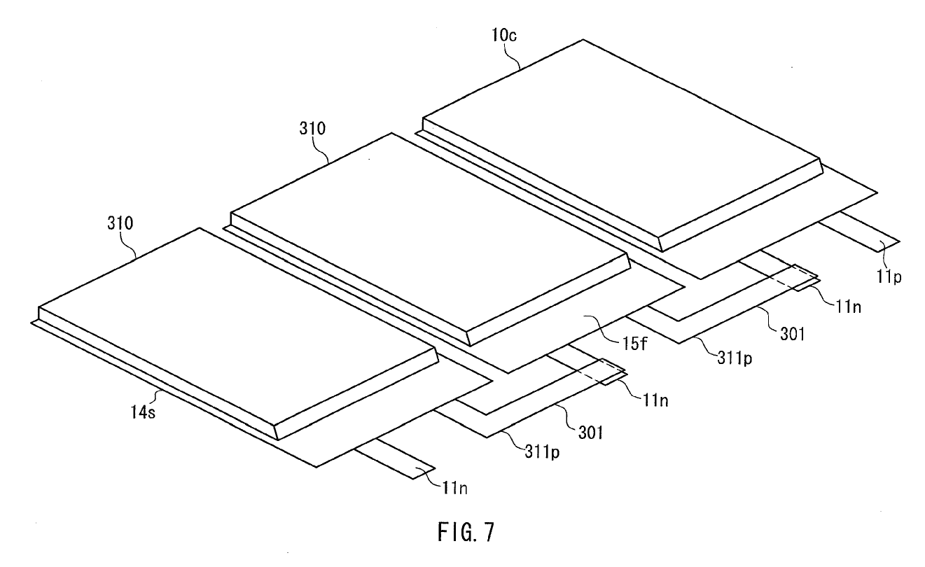

FIG. 7 is a perspective view showing a state in which two batteries 310 are used in place of the batteries 10a and 10b of Embodiments 1 and 2, and three batteries are arranged on the same plane in the same manner as the batteries shown in FIGS. 3A and 4A. The tip of the bridging part 301 of the positive electrode tab 311p of the battery 310 is placed over the tip of the negative electrode tab 11n of a battery adjacent to the positive electrode tab 311p side of the battery 310. In this state, the bridging part 301 and the negative electrode tab 11n that are placed one on top of the other are electrically connected. The manner of connection is the same as that described with reference to FIG. 3B of Embodiment 1 and FIG. 4B of Embodiment 2. Thus, the three batteries 310, 310, and 10c are connected in series. FIG. 7 corresponds to FIG. 3B of Embodiment 1 and FIG. 4B of Embodiment 2. Thereafter, the battery module of Embodiment 3 can be produced in the same manner as in Embodiment 1 or Embodiment 2. While the connecting members 30a and 30b are placed over the front sealing parts 15f of the batteries in Embodiments 1 and 2, the bridging parts 301 are placed over the front sealing parts 15f of the batteries in Embodiment 3.

With reference to FIG. 7, a case where a battery module that includes three batteries has been described, but the battery module can be configured with four or more batteries using the battery 310 of Embodiment 3. As described in Embodiments 1 and 2, in the case where n (n is an integer of 3 or greater) batteries 10a, 10b, 10c, and so on up to 10n are arranged on the same plane, the batteries other than the n^{th} battery 10n are replaced with the battery 310 of Embodiment 3.

While the positive electrode tab 311p is substantially L-shaped in FIG. 6A, a negative electrode tab 311n may be substantially L-shaped as viewed from above as shown in FIG. 6B. The bridging part 301 of the negative electrode tab 311n that extends substantially in parallel with the front side 14f projects more outward than the lateral side 14s that is closer to the negative electrode tab 311n. The battery 310′ shown in FIG. 6B can be used in place of the batteries 10b and 10c shown in FIG. 3A of Embodiment 1 and FIG. 4A of Embodiment 2. As described in Embodiments 1 and 2, in the case where n (n is an integer of 3 or greater) batteries 10a, 10b, 10c, and so on up to 10n are arranged on the same plane, the batteries other than the first battery 10a may be replaced with the battery 310′ shown in FIG. 6B.

Although not shown, the battery module may be configured with batteries each having the substantially L-shaped positive electrode tab 311p and the substantially L-shaped negative electrode tab 311n. In this case, the bridging part 301 of the positive electrode tab 311p and the bridging part 301 of the negative electrode tab 311n are electrically connected between adjacent batteries.

In Embodiments 1 and 2 in order to connect the batteries in series, connecting members that are separate from the positive electrode tabs 11p and the negative electrode tabs 11n are used, and therefore the connection resistance in the places of connection of the connecting members with the positive electrode tabs 11p and the negative electrode tabs 11n is increased. In Embodiment 3, because the positive electrode tabs and the negative electrode tabs are directly connected without connecting members, it is possible to suppress an increase of the connection resistance of the electrically conducting path resulting from electrically connecting the positive electrode tab and the negative electrode tab. Also, no connecting member is necessary, and therefore the number of components constituting the battery module can be reduced.

Other than the above-described features, Embodiment 3 is identical to Embodiments 1 and 2. The descriptions of Embodiments 1 and 2 are similarly applicable to Embodiment 3.

### Embodiment 4

As with Embodiment 3 described above, also in Embodiment 4, adjacent batteries are electrically connected without a connecting member.

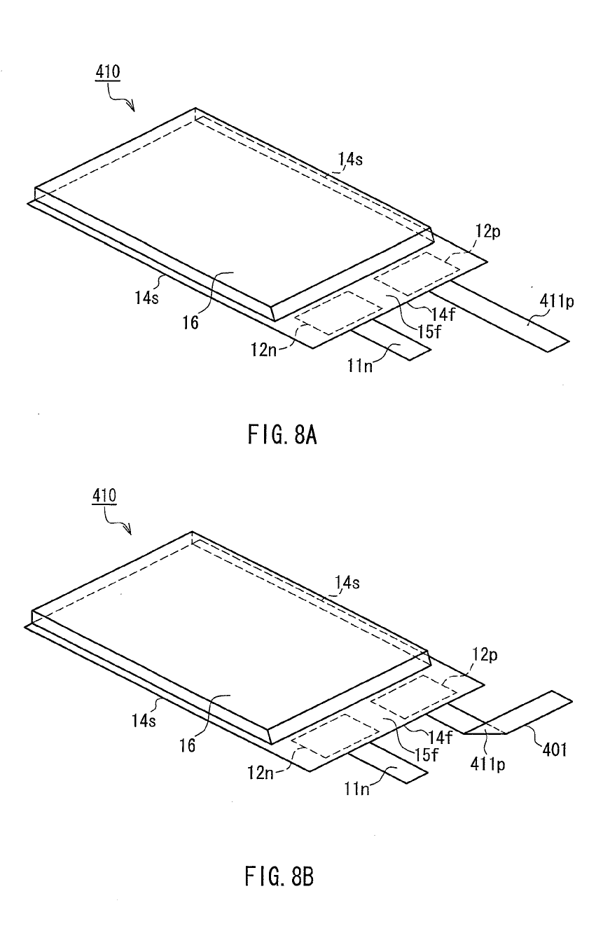

FIG. 8A is a perspective view of a battery 410 as viewed from above that is used in a battery module of Embodiment 4 of the present invention. A positive electrode tab 411p of the battery 410 is longer than the negative electrode tab 11n. In Embodiment 4, the relatively long positive electrode tab 411p is folded at a substantially right angle so as to be substantially L-shaped as viewed from above as shown in FIG. 8B. The portion of the tip of the folded positive electrode tab 411p extending substantially in parallel with the front side 14f is referred to as a bridging part 401. The bridging part 401 projects more outward than the lateral side 14s that is closer to the positive electrode tab 411p. The battery 410 of FIG. 8B is used in place of the batteries 10a and 10b shown in FIG. 3A of Embodiment 1 and FIG. 4A of Embodiment 2. A method for producing the battery module of Embodiment 4 using the battery 410 of FIG. 8B is the same as Embodiment 3 that uses the battery 310.

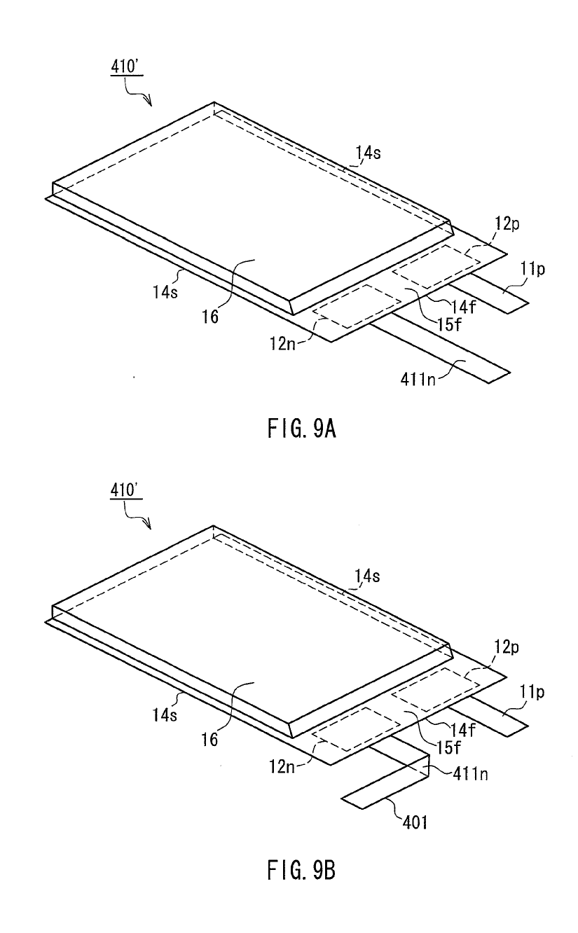

While the positive electrode tab 411p is longer than the negative electrode tab 11n in FIG. 8A, a negative electrode tab 411n may be longer than the positive electrode tab 11p as shown in FIG. 9A. In this case, the relatively long negative electrode tab 411n is folded at a substantially right angle so as to be substantially L-shaped as viewed from above as shown in FIG. 9B. The portion of the tip of the folded negative electrode tab 411n extending substantially in parallel with the front side 14f is referred to as the bridging part 401. The bridging part 401 projects more outward than the lateral side 14s that is closer to the negative electrode tab 411n. The battery 410′ of FIG. 9B is used in place of the batteries 10b and 10c shown in FIG. 3A of Embodiment 1 and FIG. 4A of Embodiment 2. A method for producing the battery module of Embodiment 4 using the battery 410′ of FIG. 9B is the same as Embodiment 3 that uses the battery 310′.

Although not shown, the battery module may be configured with batteries each having the positive electrode tab 411p that is folded so as to be substantially L-shaped and the negative electrode tab 411n that is folded so as to be substantially L-shaped. In this case, the bridging part 401 of the positive electrode tab 411p and the bridging part 401 of the negative electrode tab 411n are electrically connected between adjacent batteries.

As described in Embodiment 3, a battery module can be configured with four or more batteries using the battery of Embodiment 4.

In Embodiment 4, as in Embodiment 3, because the positive electrode tabs and the negative electrode tabs are directly connected without connecting members, it is possible to suppress an increase of the connection resistance of the electrically conducting path resulting from electrically connecting the positive electrode tab and the negative electrode tab. Also, no connecting member is necessary, and therefore the number of components constituting the battery module can be reduced.

Unlike in Embodiment 3, in Embodiment 4, neither the positive electrode tab nor the negative electrode tab needs to have a complex shape, i.e., to be substantially L-shaped, and thus the positive electrode tab and the negative electrode tab can be easily produced and are advantageous in terms of cost reduction.

Other than the above-described features, Embodiment 4 is identical to Embodiments 1 to 3. Descriptions of Embodiments 1 to 3 are similarly applicable to Embodiment 4.

### Embodiment 5

In some cases, the voltage of each battery that constitutes a battery module needs to be monitored. In Embodiment 5, this is attainable by providing a voltage monitoring terminal on an electrically conducting path that electrically connects the positive electrode tab and the negative electrode tab between adjacent batteries.

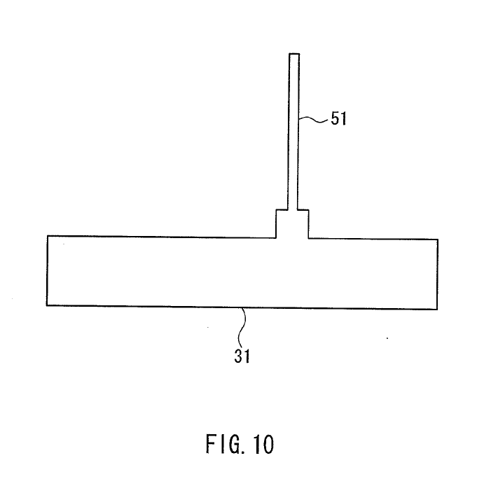

In the case where adjacent batteries are electrically connected using a connecting member as in Embodiments 1 and 2, it is possible to use as a connecting member a connecting member 31 furnished with a voltage monitoring terminal 51 as shown in FIG. 10. The connecting member 31 is different from the connecting members 30a and 30b of Embodiments 1 and 2 in that the voltage monitoring terminal 51 projects from one of the opposing lateral sides. The shape of the voltage monitoring terminal 51 is not limited to that shown in FIG. 10, and the voltage monitoring terminal 51 may take another shape. Also, in FIG. 10, the voltage monitoring terminal 51 is disposed slightly off-center in the longitudinal direction of the connecting member 31, but the position of the voltage monitoring terminal 51 in the longitudinal direction of the connecting member 31 is not limited to this.

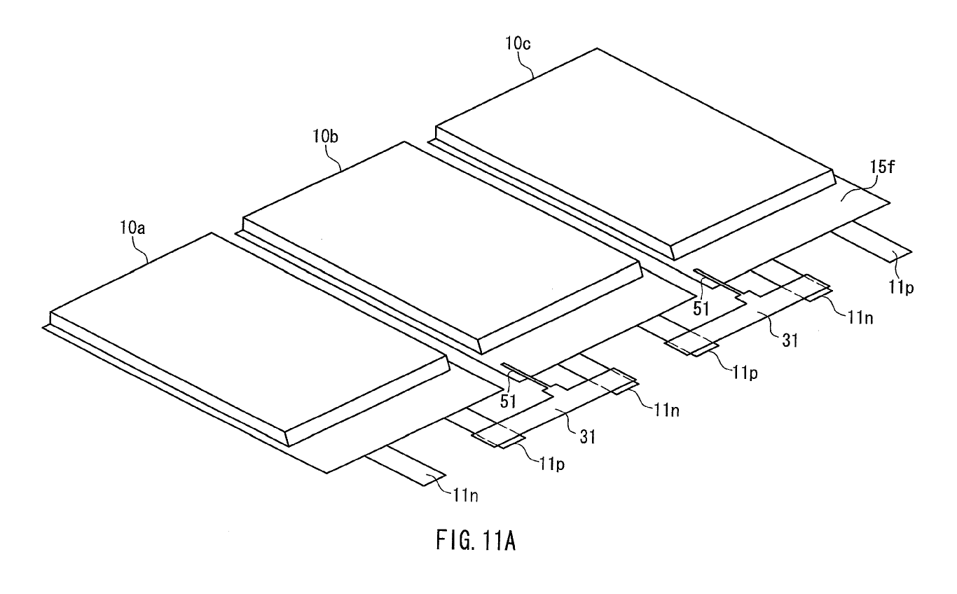

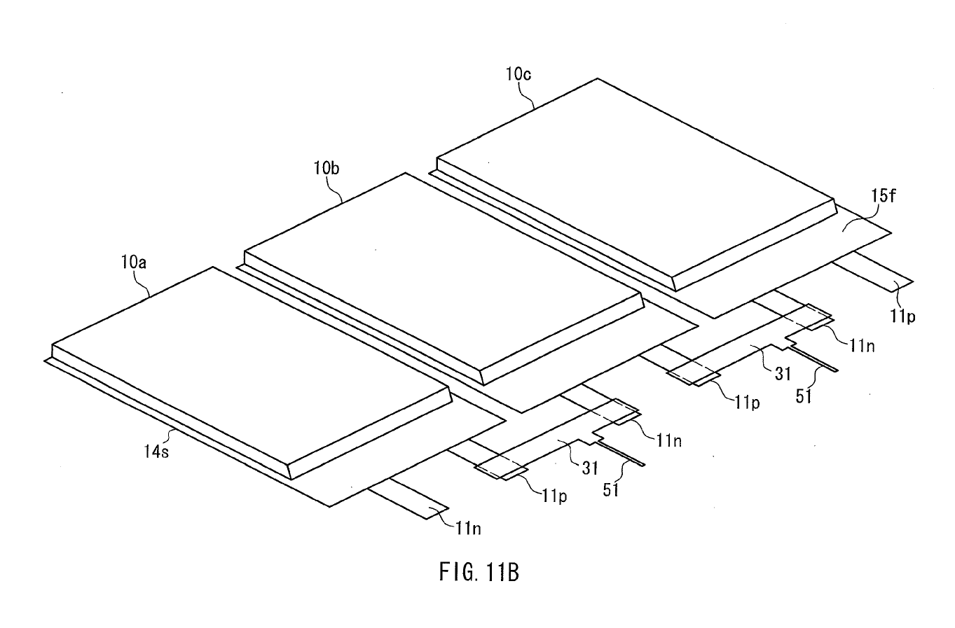

FIG. 11A is a perspective view of the three batteries 10a, 10b, and 10c in which the negative electrode tab 11n and the positive electrode tab 11p are electrically connected by the connecting member 31 between adjacent batteries. With the voltage monitoring terminal 51 being on the battery side, the respective ends of the connecting member 31 are connected to the tip of the negative electrode tab 11n and the tip of the positive electrode tab 11p. FIG. 11A corresponds to FIG. 3B of Embodiment 1 and FIG. 4B of Embodiment 2. Thereafter, a battery module of Embodiment 5 can be produced in the same manner as in Embodiment 1 or Embodiment 2. As described in Embodiments 1 and 2, because the positive electrode tabs 11p and the negative electrode tabs 11n to which the connecting members 31 are connected are folded such that the connecting members 31 are placed over the front sealing parts 15f of the batteries, the voltage monitoring terminals 51 project toward the side opposite the batteries in the eventually obtained battery module. Furnishing wiring on the voltage monitoring terminals 51 makes it possible to monitor the voltage of each of the batteries 10a, 10b, and 10c that constitute the battery module.

Note that in the case where neither the positive electrode tab 11p nor the negative electrode tab 11n is folded, and the connecting member 31 is not placed over the front sealing part 15f of a battery, the respective ends of the connecting member 31 are connected to the tip of the negative electrode tab 11n and the tip of the positive electrode tab 11p, with the voltage monitoring terminal 51 being disposed on the side opposite the battery as shown in FIG. 11B.

In the case where adjacent batteries are electrically connected without a connecting member as in Embodiments 3 and 4, the voltage monitoring terminal 51 can be integrated into the bridging part 301 or 401 of an electrode tab that constitutes an electrically conducting path between adjacent batteries.

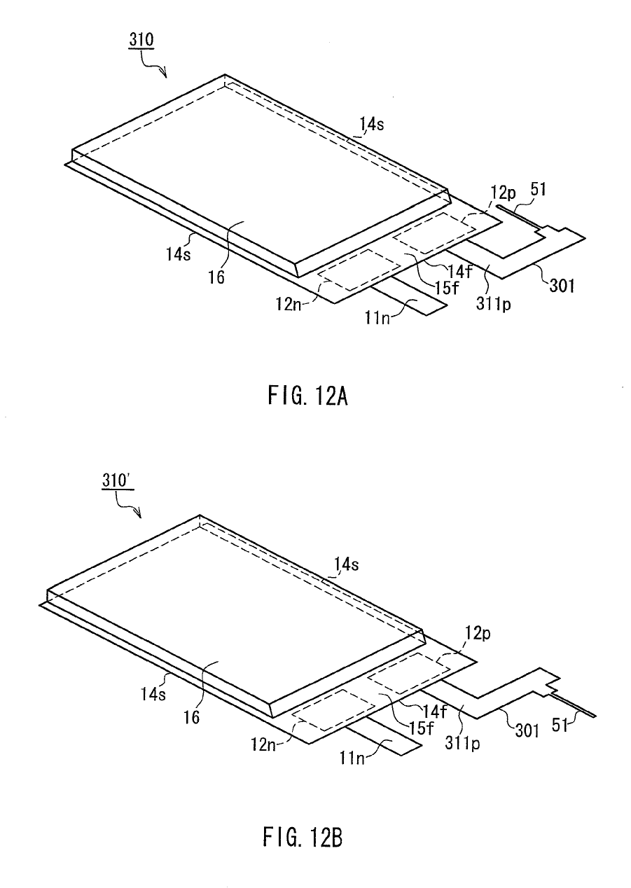

FIG. 12A shows an example in which the voltage monitoring terminal 51 is provided on the bridging part 301 of the positive electrode tab 311p that is substantially L-shaped of the battery 310 shown in FIG. 6A of Embodiment 3. Because the positive electrode tab 311p will be folded such that the bridging part 301 is placed over the front sealing part 15f of the battery, the voltage monitoring terminal 51 is provided on a lateral side of the bridging part 301 that is on the battery side (power generating element side) as in FIG. 11A. Note that in the case where the positive electrode tab 311p is not folded, and the bridging part 301 is not placed over the front sealing part 15f of the battery, the voltage monitoring terminal 51 is provided on a lateral side of the bridging part 301 that is on the side opposite the battery (power generating element) as shown in FIG. 12B.

In the case where the negative electrode tab 311n is substantially L-shaped as shown in FIG. 6B of Embodiment 3, although not shown, the voltage monitoring terminal 51 may be provided on a lateral side of the bridging part 301 of the negative electrode tab 311n that is on the battery side (power generating element side) or on the side opposite thereto as in FIG. 12A or FIG. 12B.

As described above, the battery module of Embodiment 5 can be obtained in the same manner as in Embodiment 3 using a battery provided with the voltage monitoring terminal 51 on the bridging part 301of the substantially L-shaped positive electrode tab 311p or negative electrode tab 311n.

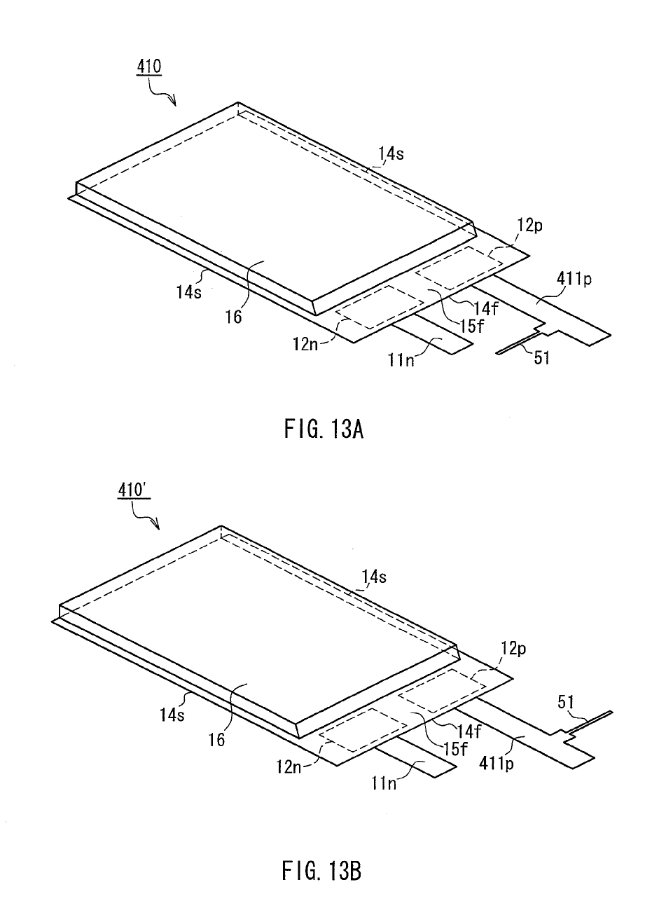

FIG. 13A shows an example in which the voltage monitoring terminal 51 is provided in a portion that serves as the bridging part 401 (see FIG. 8B) of the relatively long positive electrode tab 411p of the battery 410 shown in FIG. 8A of Embodiment 4. Because the positive electrode tab 411p will be folded such that the bridging part 401 is placed over the front sealing part 15f of the battery, the voltage monitoring terminal 51 is provided on a lateral side on the negative electrode tab 11n side of the positive electrode tab 411p. Note that in the case where the positive electrode tab 411p is not folded, and the bridging part 401 is not placed over the front sealing part 15f of the battery, the voltage monitoring terminal 51 is provided on a lateral side of the positive electrode tab 411p on the side opposite to the negative electrode tab 11n as shown in FIG. 13B.

In the case where the negative electrode tab 411n is relatively long as shown in FIGS. 9A and 9B of Embodiment 4, although not shown, the voltage monitoring terminal 51 may be provided on a lateral side on the positive electrode tab 11p side or the side opposite thereto of the negative electrode tab 411n in a portion that serves as the bridging part 401 as in FIGS. 13A or 13B.

As described above, the battery module of Embodiment 5 can be obtained in the same manner as in Embodiment 4 using a battery provided with the voltage monitoring terminal 51 in a portion that serves as the bridging part 401 of the relatively long positive electrode tab 411p or negative electrode tab 411n.

In Embodiment 5, because the voltage monitoring terminal 51 is provided on the electrically conducting path that connects adjacent batteries, it is possible to monitor the voltage of each battery that constitutes the battery module.

Also, because the voltage monitoring terminal 51 is integrated into the connecting member, the positive electrode tab, or the negative electrode tab that constitutes the electrically conducting path, the step of attaching the voltage monitoring terminal 51 to the electrically conducting path is not needed. Also, an increase of the number of components in the case where the voltage monitoring terminal 51 is attached as a separate member to the electrically conducting path and an increase of connection resistance generated in a portion where the electrically conducting path and the voltage monitoring terminal 51 are connected can be avoided.

### Embodiment 6

In Embodiment 6, output terminals for a battery module are attached to the positive electrode tab 11p and the negative electrode tab 11n at the respective ends of a plurality of batteries that are connected in series.

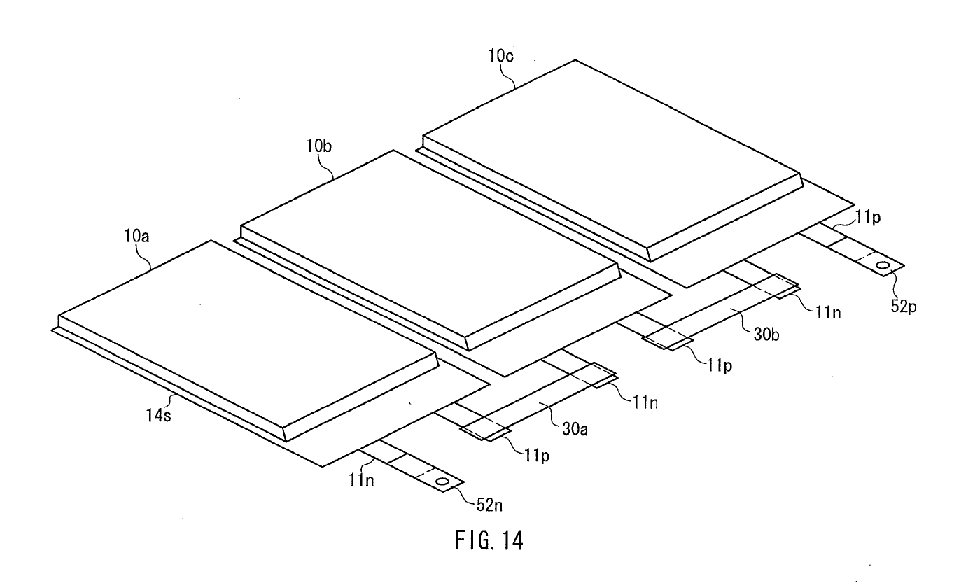

FIG. 14 is a perspective view showing an example in which the step of attaching a positive electrode terminal 52p and a negative electrode terminal 52n that serve as output terminals is applied to the battery modules of FIG. 3B of Embodiment 1 and FIG. 4B of Embodiment 2. The tip of the negative electrode tab 11n of the battery 10a and one end of the negative electrode terminal 52n are placed one on top of the other and are thus connected. Also, the tip of the positive electrode tab 11p of the battery 10c and one end of the negative electrode terminal 52p are placed one on top of the other and are thus connected. The manner of connecting the output terminals 52p and 52n to the electrode tabs 11p and 11n, respectively, is not particularly limited, and is preferably the same as the manner of connecting the connecting members 30a and 30b to the electrode tabs 11p and 11n.

Connection of the output terminals 52p and 52n to the electrode tabs 11p and 11n, respectively, is preferably carried out simultaneously with connection of the connecting members 30a and 30b to the electrode tabs 11p and 11n. As can be easily understood from FIG. 14, the electrode tabs 11p and 11n are cyclically arranged on the same plane along a straight line. Therefore, it is easy to automate the operation of connecting these components. Also, when the output terminals 52p and 52n are connected to the electrode tabs 11p and 11n, respectively, a risk of a short circuit accident caused by an accidental contact of a connecting tool with another electrode tab is extremely low.

The shapes and the dimensions of the output terminals 52p and 52n are suitably determined. In order to make it easy to fix wiring, through-holes may be formed in the output terminals 52p and 52n at the ends on the side opposite the side on which the electrode tabs 11p and 11n are connected, or nuts may be attached by a method such as welding or crimping. The materials of the output terminals 52p and 52n are not particularly limited, and are suitably selected in consideration of, for example, the ease of connection to the electrode tabs 11p and 11n and the ease of connection of wiring to the output terminals 52p and 52n.

FIG. 14 corresponds to FIG. 3B of Embodiment 1 and FIG. 4B of Embodiment 2. Thereafter, a battery module of Embodiment 6 can be produced in the same manner as in Embodiment 1 or Embodiment 2.

The positive electrode terminal 52p and the negative electrode terminal 52n may be attached as described above to the battery modules of Embodiments 3 to 5.

In Embodiment 6, the output terminals 52p and 52n are attached to a battery module, thus making it easy to provide wiring on the battery module.

Also, carrying out the step of connecting the output terminals 52p and 52n to the electrode tabs 11p and 11n, respectively, simultaneously with the step of connecting all batteries that constitute the battery module so as to be in series while the batteries are arranged on the same plane along a straight line (for example, FIG. 3 of Embodiment 1, FIG. 4 of Embodiment 2) makes it possible to efficiently carry out the step of attaching the output terminals 52p and 52n while reducing the possibility of a short circuit accident.

### Embodiment 7

In Embodiment 7, a plurality of batteries constituting a battery module are each retained in a case.

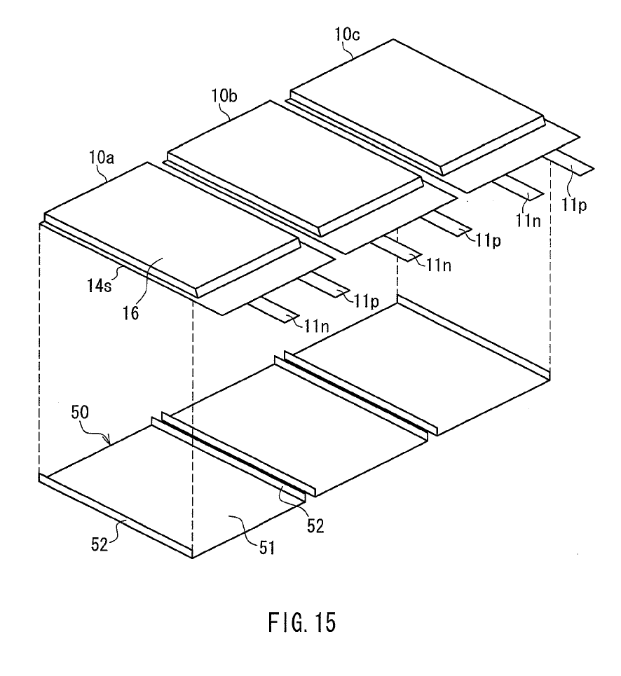

FIG. 15 is a perspective view showing three cases 50 in which the batteries 10a, 10b, and 10c are accommodated. Each case 50 includes a retainer plate 51 that comes into contact with the lower surface of the battery 10a, 10b, or 10c and a pair of side plates 52 that are provided at respective lateral edges of the retainer plate 51 and are substantially perpendicular to the retainer plate 51. The interval between a pair of the side plates 52 is substantially the same as the distance between a pair of the lateral sides 14s of a battery. The height of each side plate 52 (dimension of the side plate 52 in the normal line direction of the retainer plate 51) is substantially the same as the thickness of a battery. Three cases 50 are disposed on the same plane such that the side plates 52 of adjacent cases 50 face each other. A battery is inserted between a pair of the side plates 52 and is thus retained in the case 50. The lower surface of a battery and the retainer plate 51 may be fixed with double-sided adhesive tape so as not to allow the battery to move over or fall out of the case 50.

The batteries 10a, 10b, and 10c retained in the cases 50 in this manner are disposed as shown in FIG. 3A of Embodiment 1 or FIG. 4A of Embodiment 2, and then a battery module can be produced in the same manner as in Embodiments 1 and 2. Also, the cases 50 of Embodiment 7 are applicable to the battery modules of Embodiments 3 to 6. In the step of producing a battery module, the cases 50 and batteries accommodated and retained therein are handled integrally.

The cases 50 can be composed of a material that can be regarded as being substantially rigid. Batteries are retained in such cases 50, and thereby the lateral sides 14s of batteries that have flexibility are covered with the side plates 52 of the cases 50 that is substantially non-deformable, thus making it easy to place batteries one on top of the other in the production process of a battery module. Also, even when the finished battery module in a state of being accommodated in a housing receives an impact or vibrations, the lateral sides 14s of batteries do not deform, thus making it possible to retain the batteries in predetermined positions in the housing.

In the case where the cases 50 are composed of a material that has good heat conductivity (for example, a metallic material such as aluminum, copper, or stainless steel), contact of the side plates 52 with the inner surface of the housing allows the heat of batteries to be conducted to the housing.

In the case where the cases 50 are composed of an insulative material (for example, a resin material), insulation between adjacent batteries can be enhanced.

In connection with FIG. 15, it is preferable that the adjacent cases 50 are connected to each other with adhesive tape or the like before the batteries 10a, 10b, and 10c are accommodated therein. It is desirable that adhesive tape is applied to such a place that folding along the dashed double-dotted lines 42 and 43 of FIGS. 3C and 4C can be performed. Connecting the adjacent cases 50 makes it possible to prevent the adjacent batteries from being separated during the production process of a battery module, thus further enhancing the operational efficiency of battery module production.

Three cases 50 are shown in FIG. 15, but the number of cases 50 is set according to the number of batteries constituting a battery module.

Embodiments 1 to 7 provided above are merely illustrative. The present invention is not limited to Embodiments 1 to 7, and can be suitably modified.

The battery modules of Embodiments 1 to 7 described above use the three-side-sealed batteries 10 shown in FIGS. 1A and 1B, but the battery module of the present invention can be configured in the same manner using the four-side-sealed batteries 20 shown in FIGS. 2A and 2B. Moreover, the battery module of the present invention can be configured in the same manner using thin plate batteries other than the batteries 10 and 20.

The number of batteries constituting the battery module is not limited to three, and may be four or greater.

The field of application of the present invention is not particularly limited, and the present invention is preferably applicable to a battery module for use in power sources of various transportation devices such as automobiles and motorcycles, personal digital assistants, uninterruptible power supplies (UPSs), and the like.

### DESCRIPTION OF REFERENCE CHARACTERS

1, 2 Battery module
10, 10a, 10b, 10c, 20, 310, 310′, 410, 410′ Thin plate battery
11p, 311p, 411p Positive electrode tab
11n, 311n, 411n Negative electrode tab
13 Laminate sheet (exterior member)
14f Front side
14s Lateral side
14r Rear side
15f Front sealing part
16 Projecting region
30a, 30b, 31 Connecting member
41, 42, 43, 44 Folding line
50 Case
51 Voltage monitoring terminal
52 Side plate
52p, 52n Output terminal
301, 401 Bridging part

What is claimed is:

1. A battery module comprising a plurality of thin plate batteries that are placed one on top of the other, the plurality of thin plate batteries each having a substantially rectangular shape as viewed from above, wherein
the plurality of thin plate batteries each have a positive electrode tab and a negative electrode tab extending from a front side,
the positive electrode tab and the negative electrode tab of adjacent thin plate batteries face each other,
the positive electrode tab and the negative electrode tab that face each other are electrically connected such that the plurality of thin plate batteries are connected in series, and
an electrically conducting path that electrically connects the positive electrode tab and the negative electrode tab is folded along a folding line that is parallel to a lateral side adjacent to the front side.

2. The battery module according to claim 1, wherein
the positive electrode tab and the negative electrode tab are electrically connected via a connecting member that is a member separate from the positive electrode tab and the negative electrode tab, and
the connecting member is folded along the folding line.

3. The battery module according to claim 1, wherein
the positive electrode tab and the negative electrode tab are directly connected, and
the positive electrode tab or the negative electrode tab is folded along the folding line.

4. The battery module according to claim 1, wherein
the electrically connected positive electrode tab and negative electrode tab are folded along the folding line that is parallel to the front side.

5. The battery module according to claim 4, wherein
the thin plate batteries each have a power generating element and an exterior member that accommodates the power generating element,
a region corresponding to the power generating element projects away relative to a region where the exterior member is sealed, thus creating a level difference on one side of the thin plate battery, and
the positive electrode tab and the negative electrode tab are folded such that at least a part of the electrically conducting path faces a front sealing part that is a region where the exterior member is sealed along the front side and is accommodated in a space created by the level difference.

6. The battery module according to claim 1, wherein the electrically conducting path does not project more outward than the lateral side of the thin plate battery

7. The battery module according to claim 1, wherein the electrically conducting path is provided with a voltage monitoring terminal.

8. The battery module according to claim 1, wherein the plurality of batteries are each accommodated in a case provided with a side plate that covers the lateral side.

9. A method for producing a battery module, comprising the successive steps of
(a) providing a plurality of thin plate batteries each having a substantially rectangular shape as viewed from above and including a positive electrode tab and a negative electrode tab extending from a front side;
(b) arranging the plurality of thin plate batteries on the same plane such that the front sides of the plurality of thin plate batteries form a straight line and such that the positive electrode tabs and the negative electrode tabs of the plurality of thin plate batteries are alternately disposed in a direction parallel to the front sides;
(c) electrically connecting the positive electrode tab and the negative electrode tab between adjacent thin plate batteries such that the plurality of thin plate batteries are connected in series; and
(d) placing the adjacent thin plate batteries one on top of the other by folding an electrically conducting path that electrically connects the positive electrode tab and the negative electrode tab along a folding line that is parallel to lateral sides adjacent to the front sides.

10. The method for producing a battery module according to claim 9, wherein in the step (c), the positive electrode tab and the negative electrode tab are electrically connected via a connecting member that is a member separate from the positive electrode tab and the negative electrode tab.

11. The method for producing a battery module according to claim 9, wherein
one of the positive electrode tab and the negative electrode tab is substantially L-shaped, and
in the step (c), said one of the positive electrode tab and the negative electrode tab that is substantially L-shaped is directly connected to the other.

12. The method for producing a battery module according to claim 9, further comprising the step (e) of folding one of the positive electrode tab and the negative electrode tab so as to be substantially L-shaped, wherein
in the step (c), said one of the positive electrode tab and the negative electrode tab that is folded so as to be substantially L-shaped is directly connected to the other.

13. The method for producing a battery module according to claim 9, further comprising the step (f) of folding the positive electrode tab and the negative electrode tab that are electrically connected in the step (c) along a folding line that is parallel to the front sides.

14. The method for producing a battery module according to claim 13, wherein the step (f) is carried out before the electrically conducting path is folded.

15. The method for producing a battery module according to claim 13, wherein the step (f) is carried out after the electrically conducting path is folded.

16. The method for producing a battery module according to claim 9, further comprising the step (g) of attaching output terminals to the positive electrode tab and the negative electrode tab, among the positive electrode tabs and the negative electrode tabs of the plurality of thin plate batteries, that are not electrically connected to tabs that have different polarities in the step (c), wherein
the step (g) is carried out simultaneously with the step (c).

17. The method for producing a battery module according to claim 9, further comprising the step (h) of accommodating the thin plate batteries in cases provided with side plates that cover the lateral sides of the thin plate batteries, the step (h) being carried out between the step (a) and the step (c).
